(19) United States
(12) Patent Application Publication
(10) Pub. No.: US 2004/0235535 A1
(43) Pub. Date: Nov. 25, 2004

(54) Communication system and communication apparatus

(75) Inventors: Yoshitatsu Kajiwara, Kasuga-shi (JP); Takashi Kitada, Ogoori-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/848,404

(22) Filed: May 19, 2004

(30) Foreign Application Priority Data
May 20, 2003 (JP) 2003-141731

(51) Int. Cl. H04Q 7/20; H04M 1/00

(52) U.S. Cl. 455/573; 455/465; 455/426.1

(57) ABSTRACT

In a communication system arranged by a cordless handset, a base unit, and a charging base, the charging base is constructed by employing a cordless handset power supply unit for charging a secondary battery of the cordless handset; a portable terminal appliance power supply unit for charging the portable terminal appliance; and further, a data transmitting and receiving unit capable of transmitting and receiving data between the portable terminal appliance and the cordless handset data storage unit. With employment of this arrangement, the data transmitting and receiving unit of the charging base transmits and receives data between the portable terminal appliance and the cordless handset, and transfers a telephone number from the cordless handset to the portable terminal appliance, or from the portable terminal appliance to the cordless handset. This transferred telephone number can be utilized so as to make a telephone call. Also, data which is entered to the portable terminal appliance is transmitted via the charging base and the cordless handset to a base unit data storage unit, so that this data can be utilized by the base unit.

### BACKGROUND OF THE INVENTION

The present invention relates to a communication system and a communication apparatus, which perform charging operation of a portable terminal appliance, and also perform data transmitting and receiving operation with respect to the portable terminal appliance.

Conventionally, as communication apparatus which transmit and receive data with respect to portable terminal appliances, there are facsimile apparatus connectable to portable telephones in either a wire manner or a wireless manner, printing apparatus (facsimiles) which charge portable telephones while performing data communications, and the like. As the facsimile apparatus connectable to the portable telephones in either the wire manner or the wireless manner, for instance, there is such a facsimile apparatus described in Japanese Laid-open Patent Application No. 2001-218094. As the printing apparatus which charges the portable telephones while performing the data communications, for example, there such a printing apparatus described in Japanese Laid-open Patent Application No. 2002-99364.

That is, as to the facsimile apparatus described in JP-A-2001-218094, the portable telephone is connected to the facsimile apparatus by utilizing the externally-connected connection unit, and the data of the portable telephone is stored in the memory in the facsimile apparatus. Then, an arbitrary telephone number is retrieved from the telephone number data stored in the memory, and thus, a telephone call can be made, and a facsimile transmitting operation can be carried out by utilizing the retrieved telephone number. Also, while the printing function of the facsimile apparatus is used, the telephone number data stored in the memory can be printed as the telephone number notebook. In the printing apparatus described in JP-A-2002-99364, while the portable telephone is connected to the printing apparatus by using the-connector, the portable telephone is charged, and at the same time, the data of the portable telephone is stored in the memory in the printing apparatus. Also, the data stored in the memory can be printed by utilizing the printing function.

However, in the above-explained conventional communication apparatus, since the communication apparatus main body (base unit) is equipped with the function for charging the portable telephone so as to transmit and receive the data, the operation of this communication apparatus is restricted as follows: That is, when the portable terminal apparatus is charged and the data is transmitted and received between the base unit and the portable terminal appliance, the operation of the communication apparatus is permitted within such a range that the charging communication cable can be reached from the base unit.

Also, the operation of this communication apparatus is restricted as follows: That is, the data transmitting and receiving operation cannot be carried out between the portable terminal appliance and the cordless handset belonging to the base unit, so that the data of the portable terminal appliance cannot be utilized by any appliance other than the base unit. The range where the data which could be transmitted and received can be utilized is also narrowered.

In addition, a different point between a portable terminal appliance and a fixed terminal appliance is not only such a fact as to whether or not movement is made, but also a different property, namely, used by a single person and used by a plurality of persons. As a consequence, in the conventional apparatus, the function capable of protecting the personal data is provided. However, in such a case that the portable terminal appliance is connected to the base unit so as to charge the personal terminal appliance and transmit and receive the data between the portable terminal appliance and the base unit, the portable terminal appliance must be left at the place where the base unit is installed until the process operation as to the portable terminal appliance is accomplished. The portable terminal appliance which is personally used remains left in such a range that this portable terminal apparatus is connectable to the base unit which is intended to be used by a plurality of persons. In other words, this condition implies that the portable terminal appliance into which the personal information has been stored is left at such a place that a third party becomes aware of this portable terminal appliance. As a result, there is a certain risk that the personal information may be leaked. In an actual case, since portable terminal appliances are personally used, charging operations of these portable terminal appliances are carried out within the own personal rooms. Under such a use condition, cordless handsets which are originally portable should be equipped with a function capable of charging portable terminal appliances and also another function capable of transmitting and receiving data with respect to these portable terminal appliances.

### SUMMARY OF THE INVENTION

An object of the present invention is to provide a communication system capable of extending a data transmittable and receivable range, and also, capable of physically protecting personal information of a portable terminal appliance.

To solve the above-described problem, a communication system, according to an aspect of the present invention, is featured by that while the communication system is arranged by a cordless handset, a base unit, and a charging base, a power supply unit capable of charging a secondary battery of another portable terminal appliance is provided with the charging base in addition to a power supply unit for charging a secondary battery employed in the cordless handset. Furthermore, a data transmitting and receiving unit capable of transmitting and receiving data between the cordless handset and the portable terminal appliance is provided within the charging base.

As a consequence, such a communication system capable of charging the portable terminal appliance and also capable of transmitting and receiving data between the portable terminal appliance and the cordless handset is obtained.

### BRIEF DESCRIPTION OF THE DRAWINGS

FIG. 1 is a schematic block diagram for indicating an arrangement of a communication appliance according to an embodiment 1 of the present invention.

FIG. 2 is a schematic block diagram for showing an arrangement of a communication appliance according to an embodiment 2 of the present invention.

FIG. 3 is a schematic block diagram for indicating an arrangement of a communication appliance according to an embodiment 3 of the present invention.

FIG. 4 is a schematic block diagram for showing an arrangement of a communication appliance according to an embodiment 4 of the present invention.

FIG. 5 is a schematic block diagram for indicating an arrangement of a communication appliance according to an embodiment 5 of the present invention.

FIG. 6 is a schematic block diagram for showing an arrangement of a communication appliance according to an embodiment 6 of the present invention.

FIG. 7 is a schematic block diagram for indicating an arrangement of a communication appliance according to an embodiment 7 of the present invention.

FIG. 8 is a schematic block diagram for showing an arrangement of a communication appliance according to an embodiment 8 of the present invention.

FIG. 9 is a schematic block diagram for indicating an arrangement of a communication appliance according to an embodiment 9 of the present invention.

FIG. 10 is a schematic block diagram for showing an arrangement of a communication appliance according to an embodiment 10 of the present invention.

FIG. 11 is a schematic block diagram for indicating an arrangement of a communication appliance according to an embodiment 11 of the present invention.

### DETAILED DESCRIPTION OF THE PREFERRED EMBODIMENTS

Referring now to drawings, a description is made of a communication appliance equipped with a cordless handset as an embodiment of the present invention.

### Embodiment 1

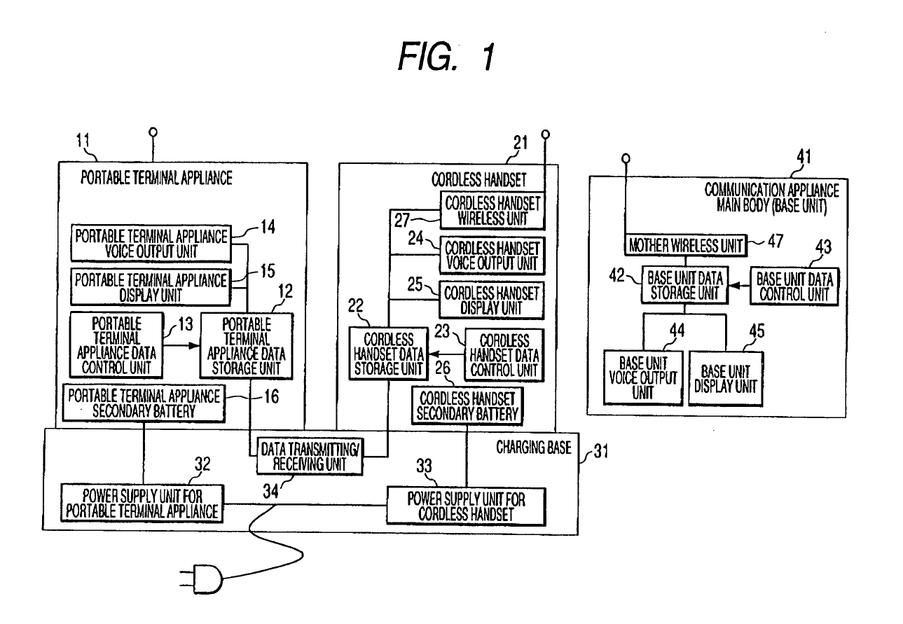

FIG. 1 is a block diagram for schematically showing an arrangement of a communication appliance according to an embodiment 1 of the present invention. In FIG. 1, reference numeral 21 shows a cordless handset belonging to a communication system of the present invention, and reference numeral 41 indicates a main body (base unit) of a communication appliance of the communication system. Reference numeral 11 represents a portable terminal appliance which is connected to this communication system. As examples of such a communication appliance equipped with a cordless handset, there are, for instance, a cordless telephone, a facsimile apparatus equipped with a cordless handset, a printer equipped with a communication function, and the like. Also, the portable terminal appliance 11 described in this embodiment 1 involves, concretely speaking, a portable telephone, a PHS (personal handyphone system), a PDA (personal digital assistants), and an electronic notebook.

In the cordless handset 21, reference numeral 22 indicates a cordless handset data storage unit into which data of the cordless handset 21 has been stored; reference numeral 23 shows a cordless handset data control unit which controls data of the cordless handset 21; reference numeral 24 represents a cordless handset voice output unit for outputting voice of the cordless handset 21; reference numeral 25 shows a cordless handset display unit which displays data of the cordless handset 21 on a screen; and reference numeral 26 indicates a cordless handset secondary battery which constitutes a power supply of the cordless handset 21; and reference numeral 27 indicates a cordless handset wireless unit which can be communicated to the base unit 41 in a wireless manner.

In the communication appliance main body (base unit) 41, reference numeral 42 indicates a base unit data storage unit into which data of the base unit 41 has been stored; reference numeral 43 shows a base unit data control unit which controls data of the base unit 41; reference numeral 44 represents a base unit voice output unit for outputting voice of the base unit 41; reference numeral 45 shows a base unit display unit which displays data of the base unit 41 and reference numeral 47 indicates a base unit wireless unit which can be communicated to the cordless handset 21 in a wireless manner.

Also, reference numeral 31 shows a charging base. In the charging base 31, reference numeral 32 indicates a power supply unit for portable terminal appliance, which supplies electric power to the portable terminal appliance 11; reference numeral 33 represents a power supply unit for cordless handset, which supplies electric power to the cordless handset secondary battery 26; and reference numeral 34 indicates a data transmitting and receiving unit which transmits and receives data between the portable terminal appliance 11 and the cordless handset 21. As previously explained, the charging base 31 can charge the cordless handset secondary battery 26 and can transmit and receive the data between the cordless handset 21 and the own charging base 31, and can charge the portable terminal appliance 11 and can transmit and receive the data between the portable terminal appliance 11 and the own charging base 31.

FIG. 1 indicates one example of the portable terminal appliance 11 according to the present invention, which can be charged and can communicate data, while this portable terminal appliance 11 is connected to the charging base 31. In the portable terminal appliance 11, reference numeral 12 shows a portable terminal appliance data storage unit into which data of the portable terminal appliance 11 has been stored; reference numeral 13 indicates a portable terminal appliance data control unit which controls data of the portable terminal appliance 11; reference numeral 14 represents a portable terminal appliance voice output unit which outputs voice of the portable terminal appliance 11; reference numeral 15 shows a portable terminal appliance display unit which displays data of the portable terminal appliance lion a screen; and reference numeral 16 shows a portable terminal appliance secondary battery which constitutes a power supply of the portable terminal appliance

As to the communication system with employment of the above-described arrangement, operations thereof will now be described. First, when data is transmitted from the portable terminal appliance 11 to the cordless handset 21, first of all, a user sets both the portable terminal appliance 11 and the cordless handset 21 to the charging base 31. Since the above-explained setting operation is carried out, the portable terminal appliance data storage unit 12 contained in the portable terminal appliance 11 is connected via the data transmitting and receiving unit 34 to the cordless handset data storage unit 22, so that a data transmitting and receiving operation is prepared.

Also, the portable terminal appliance secondary battery 16 is connected to the power supply unit 32 for portable terminal appliance, and the cordless handset secondary battery 26 is connected to the power supply unit 33 for cordless handset, respectively. After these secondary batteries and power supply units are connected to each other, both the power supply unit 32 for portable terminal appliance and the power supply unit 33 for cordless handset supply electric power are used to charge the portable terminal appliance secondary battery 16 and the cordless handset secondary battery 26, respectively.

When the user operates to commence data transmitting and receiving operation, the portable terminal appliance data storage unit 12 transmits data of the portable terminal appliance 11 to the data transmitting and receiving unit 34. In the data transmitting and receiving unit 34, the data transmitted from the portable terminal appliance data transmitting and receiving unit 16 is converted into such a data having a format which can be utilized in the cordless handset 21, and then, the format-converted data is transmitted to the cordless handset data storage unit 22. When the cordless handset data storage unit 22 receives the above-described data transmitted from the data transmitting and receiving unit 34, the cordless handset data storage unit 22 stores this received data.

The transmission of data which are transmitted from the portable terminal appliance 11 to the cordless handset 21 is accomplished by that all of data which should be transmitted are transmitted from the portable terminal appliance data storage unit 12, and then, all of the transmitted data are received by the cordless handset data storage unit 22.

The charging operations of the portable terminal appliance 11 and the cordless handset 21 are continuously carried out until the portable terminal appliance secondary battery 16 and the cordless handset secondary battery 26 are brought into full power conditions.

As previously explained, when the portable terminal appliance 11 and the cordless handset 21 are charged, and both the portable terminal appliance 11 and the cordless handset 21 are set to the charging base 31, the data is transmitted from the portable terminal appliance 11 to the cordless handset 21 It should be noted that when either the portable terminal appliance 11 or the cordless handset 21 is set to the charging base 31, data transmitting operation may be automatically commenced.

Next, when data is transmitted from the cordless handset 21 to the portable terminal appliance 11, first of all, the user sets both the portable terminal appliance 11 and the cordless handset 21 to the charging base 31. Since the above-explained setting operation is carried out, the portable terminal appliance data storage unit 12 is connected via the data transmitting and receiving unit 34 to the cordless handset data storage unit 22, and further, the portable terminal appliance secondary battery 16 is connected to the power supply unit 32 for portable terminal appliance, and also the cordless handset secondary battery 26 is connected to the power'supply unit 33 for cordless handset, respectively. After these secondary batteries and power supply units are connected to each other, both the power supply unit 34 for portable terminal appliance and the power supply unit 33 for cordless handset supply electric power are used to charge the portable terminal appliance secondary battery 16 and the cordless handset secondary battery 26, respectively.

On the other hand, in such a case that the user wants to transmit data from the cordless handset 21 to the portable terminal appliance 11, an instruction is issued from the portable terminal appliance data control unit 13 and the cordless handset data control unit 23. When the instruction for transmitting the data from the cordless handset 21 to the portable terminal appliance 11 is issued, the cordless handset storage unit 22 transmits the data of the cordless handset 21 to the data transmitting and receiving unit 34. In the data transmitting and receiving unit 34, the data transmitted from the cordless handset 21 is converted into such a data having a format which can be utilized in the portable terminal appliance 11, and then, the format-converted data is transmitted to the portable terminal appliance data storage unit 12.

When the portable terminal appliance data storage unit 12 receives the transmitted from the data transmitting and receiving unit 34, this portable terminal appliance data storage unit 12 stores this received data. The charging operations of the portable terminal appliance 11 and the cordless handset 21 are continuously carried out until the portable terminal appliance secondary battery 16 and the cordless handset secondary battery 26 are brought into full power conditions. The transmission of data which are transmitted from the cordless handset 21 to the portable terminal appliance 11 is accomplished by that all of data which should be transmitted are transmitted from the cordless handset data storage unit 22, and then, all of the transmitted data are received by the portable terminal appliance data storage unit 12.

As previously explained, the charging operations are carried out as to the portable terminal appliance 11 and the cordless handset 21. Also, the data transmission from the cordless handset 21 to the portable terminal appliance 11 is carried out in the case that both the portable terminal appliance 11 and the cordless handset 21 are set to the charging base 31, and the instructions are issued from the portable terminal appliance data control unit 13 and the cordless handset data control unit 23. Furthermore, the data can be transmitted and received between the cordless handset 21 and the base unit 41.

When data is transmitted and received from the cordless handset 21 to the base unit 41, an instruction is issued from the cordless handset data control unit 23, or the base unit data control unit 43. When an instruction for transmitting data from the cordless handset 21 to the base unit 41 is issued, data is transmitted from the cordless handset data storage unit 22 via the cordless handset wireless unit 27 to the base unit wireless unit 47 in a wireless manner. When the base unit wireless unit 47 receives the data from the cordless handset wireless unit 27, the base unit wireless unit 47 transfers the received data to the base unit data storage unit 42. The base unit data storage unit 42 stores the transferred data.

Conversely, when an instruction for transmitting data from the base unit 41 to the cordless handset 21 is issued, data is transmitted from the base unit data storage unit 42 via the base unit wireless unit 47 to the cordless handset wireless unit 27 in a wireless manner. When the cordless handset wireless unit 27 receives the data from the base unit wireless unit 47, the cordless handset wireless unit 27 transfers the received data to the cordless handset data storage unit 22. The cordless handset data storage unit 22 stores the transferred data.

Finally, the data which have been transmitted and received among the three appliances, namely, the portable telephone appliance 11, the cordless handset 21, and the base unit 41, can be utilized by the portable terminal appliance 11, the cordless handset 21, and the base unit 41. For instance, these data may be outputted in the form of voice by the portable terminal appliance voice output unit 14, the cordless handset voice output unit 24, and the base unit voice output unit 44. Alternatively, these data maybe displayed in the form of a screen on the portable terminal appliance display unit 15, the child machine display unit 25, and the mother machine display unit 45.

As previously described, in accordance with the communication system according to this embodiment 1, the data of the portable terminal appliance 11 such as a portable telephone, a PHS, a PDA, and an electronic notebook can be automatically stored in the cordless handset data storage unit 22 which is built in the cordless handset 21 of the communication appliance. As a result, the data of the portable terminal appliance 11 may be utilized in the cordless handset 21, and also, may be stored via both the cordless handset wireless unit 27 and the base unit wireless unit 47 into the base unit data storage unit 42, so that this data of the portable terminal appliance 11 may be similarly utilized in the base unit 41. Also, the data which has been stored in the cordless handset 21 and the base unit 41 may be transferred to the portable terminal appliance 11 so as to be stored as back-up data. Conversely, the data which have been owned by the portable terminal appliance 11 and the base unit 41 maybe stored into the cordless handset 21 as back-up data.

### Embodiment 2

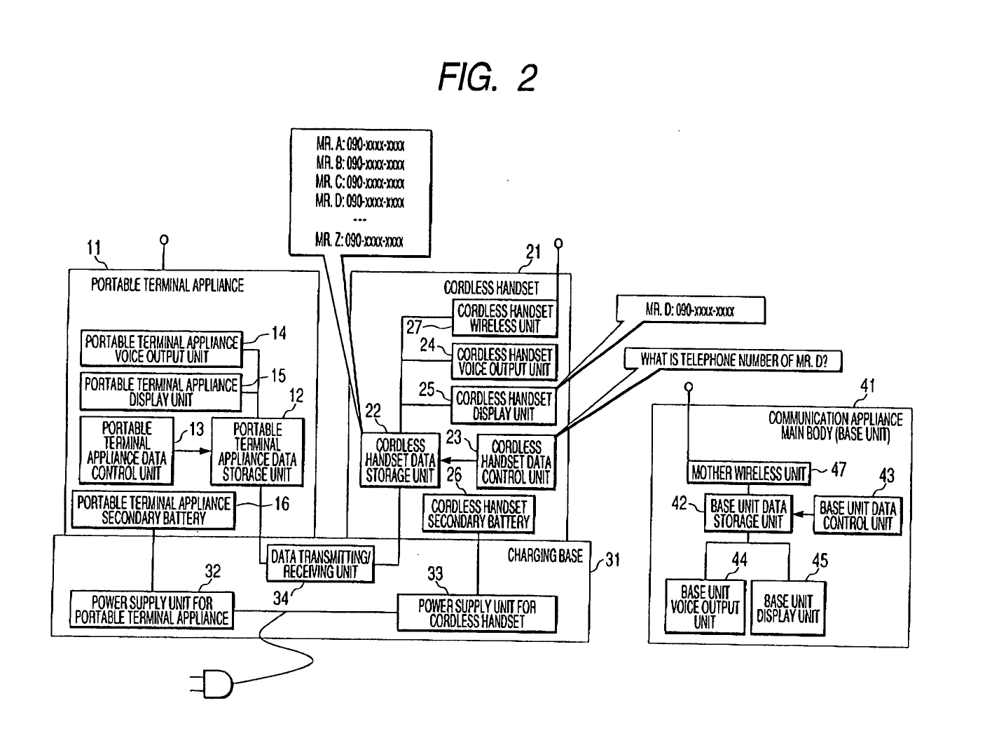

FIG. 2 is a schematic block diagram for representing a communication system according to an embodiment 2 of the present invention. In FIG. 2, a portable terminal appliance 11, a portable terminal appliance data storage unit 12, a portable terminal appliance data control unit 13, a portable terminal appliance voice output unit 14, a portable terminal appliance display unit 15, a portable terminal appliance secondary battery 16, a cordless handset 21, a cordless handset data storage unit 22, a cordless handset data control unit 23, a cordless handset voice output unit 24, a cordless handset display unit 25, a cordless handset secondary battery 26, a cordless handset wireless unit 27, a charging base 31, a power supply unit 32 for portable terminal appliance; a power supply unit 33 for cordless handset; a data transmitting and receiving unit 34; a communication appliance main body (base unit) 41, a base unit data storage unit 42, a base unit data control unit 43, a base unit voice output unit 44, abase unit display unit 45, and also, a mother wireless unit 47 are similar to those of FIG. 1, and therefore, explanations thereof are omitted.

In accordance with the embodiment 2, a telephone number which has been registered in the portable terminal appliance 11 can be transferred to the cordless handset 11. In other words, when both the portable terminal appliance 11 and the cordless handset 21 are set to the charging base 31, data as to a telephone number of the portable terminal appliance data storage unit 12 is automatically transferred via the data transmitting and receiving unit 34 employed in the charging base 31 to the cordless handset 21, and then is stored in the cordless handset data storage unit 22.

When a user issues an instruction from the cordless handset data control unit 23, a required telephone number is retrieved (MR. D is retrieved in FIG. 2). Since the required telephone number is acquired, the user can make a telephone call by using this acquired telephone call. Alternatively, the data as to the telephone number acquired by the cordless handset 21 may be transferred via the data transmitting and receiving unit 34 employed in the charging base 31 to the portable terminal appliance 11. Further, since an instruction is issued from the cordless handset data control unit 23 and the mother data control unit 43, the telephone number may be alternatively transferred to the base unit 41 in a wireless manner, so that the user of the base unit 41 may make a telephone call by using this transferred telephone number in a similar manner to the cordless handset 21.

As previously explained, in accordance with this embodiment 2, since the telephone number which has been registered in the portable terminal appliance 11 is automatically stored in the cordless handset data storage unit 22, the telephone number which has been registered in the portable terminal appliance 11 need not be newly registered in the cordless handset 21 and the base unit 41, and thus, the users of the cordless handset 21 and the base unit 41 can make telephone calls by utilizing the telephone number which has been automatically stored from the portable terminal appliance 11.

### Embodiment 3

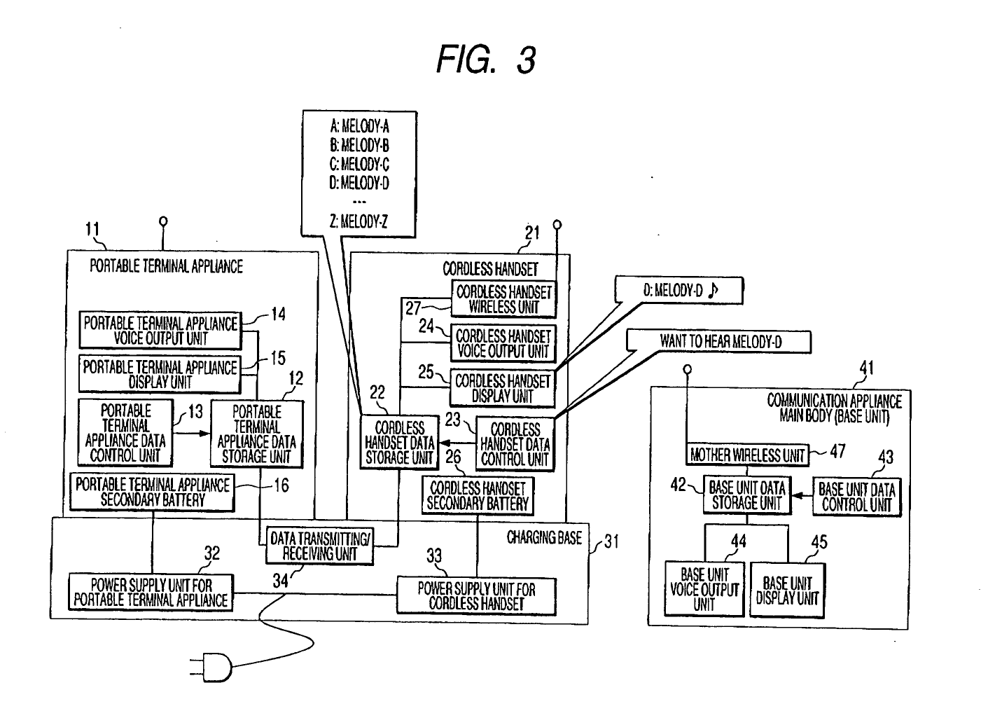

FIG. 3 is a schematic block diagram for representing a communication system according to an embodiment 3 of the present invention. In FIG. 3, a portable terminal appliance 11, a portable terminal appliance data storage unit 12, a portable terminal appliance data control unit 13, a portable terminal appliance voice output unit 14, a portable terminal appliance display unit 15, a portable terminal appliance secondary battery 16, a cordless handset 21, a cordless handset data storage unit 22, a cordless handset data control unit 23, a cordless handset voice output unit 24, a cordless handset display unit 25, a cordless handset secondary battery 26, a cordless handset wireless unit 27, a charging base 31, a power supply unit 32 for portable terminal appliance; a power supply unit 33 for cordless handset; a data transmitting and receiving unit 34; a communication appliance main body (base unit) 41, a base unit data storage unit 42, a base unit data control unit 43, a base unit voice output unit 44, a base unit display unit 45, and also, a mother wireless unit 47 are similar to those of FIG. 1, and therefore, explanations thereof are omitted.

In accordance with the embodiment 3, data as to musical information such as telephone-calling melody can be transferred from the portable terminal appliance 11. In other words, when both the portable terminal appliance 11 and the cordless handset 21 are set to the charging base 31, data as to musical information such as telephone-calling melody stored in the portable terminal appliance data storage unit 12 is automatically transferred via the data transmitting/receiving unit 34 employed in the charging base 31 to the cordless handset 21, and then is stored in the cordless handset data storage unit 22.

When a user issues an instruction from the cordless handset data control unit 23, necessary music such as telephone-calling melody is retrieved (melody “D” is retrieved in FIG. 3). Since the music such as the telephone-calling melody which is retrieved and is required is acquired, the user can hear this acquired music such as telephone-calling melody. Also, this music such as the telephone-calling melody may be alternatively set as telephone-calling sound, and/or maybe arranged. In addition, music such as telephone-calling melody which has been formed in the cordless handset 21 may be alternatively transferred to the portable terminal appliance 11. Also, since an instruction is issued from the cordless handset data control unit 23 and the mother data control unit 43, music such as telephone-calling melody may be alternatively transferred to the base unit 41 in a wireless manner, so that a user of the base unit 41 may alternatively hear and arrange the music such as the telephone-calling melody, and/or may alternatively provide formed music in a similar manner to the cordless handset 21.

As previously explained, in accordance with this embodiment 3, since the music such as the telephone-calling melody which has been registered in the portable terminal appliance 11 is automatically stored in the cordless handset data storage unit 22, the music such as the telephone-calling melody which has been registered in the portable terminal appliance 11 can be utilized in the cordless handset 21 and the base unit 41. Also, while the music such as the telephone-calling melody which has been automatically stored from the portable terminal appliance 11 is utilized, this music can be heard by the user of the cordless handset 21 and the user of the base unit 41.

### Embodiment 4

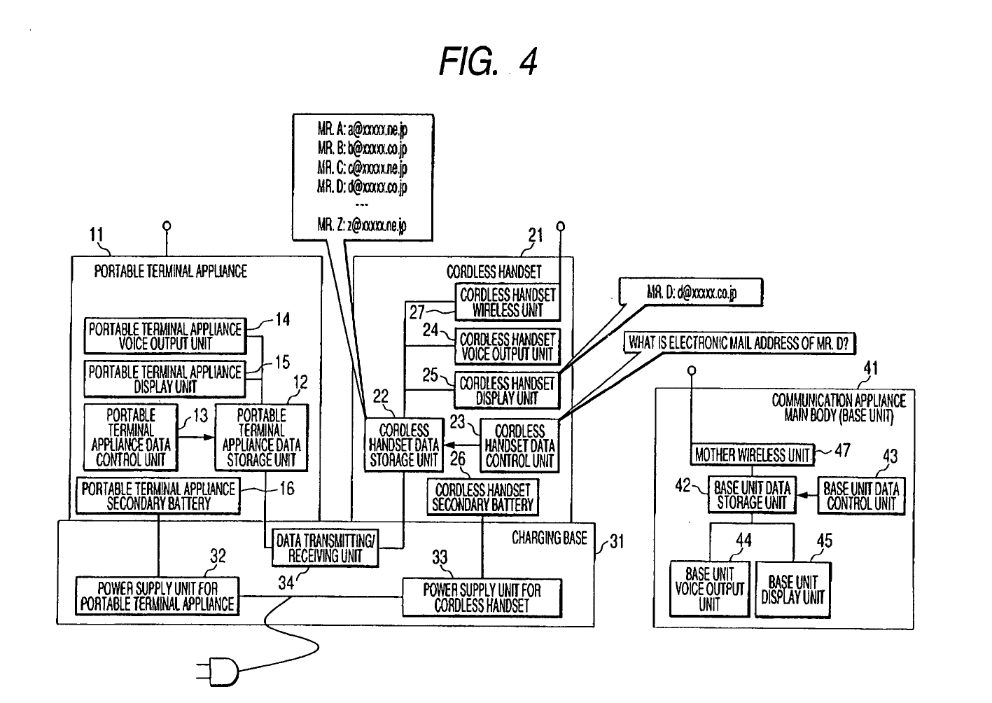

FIG. 4 is a schematic block diagram for representing a communication system according to an embodiment 4 of the present invention. In FIG. 4, a portable terminal appliance 11, a portable terminal appliance data storage unit 12, a portable terminal appliance data control unit 13, a portable terminal appliance voice output unit 14, a portable terminal appliance display unit 15, a portable terminal appliance secondary battery 16, a cordless handset 21, a cordless handset data storage unit 22, a cordless handset data control unit 23, a cordless handset voice output unit 24, a cordless handset display unit 25, a cordless handset secondary battery 26, a cordless handset wireless unit 27, a charging base 31, a power supply unit 32 for portable terminal appliance; a power supply unit 33 for cordless handset; a data transmitting and receiving unit 34; a communication appliance main body (base unit) 41, a base unit data storage unit 42, a base unit data control unit 43, a base unit voice output unit 44, abase unit display unit 45, and also, a mother wireless unit 47 are similar to those of FIG. 1, and therefore, explanations thereof are omitted.

In accordance with the embodiment 4, data as to an electronic mail and an address of an electronic mail can be transferred to the cordless handset 21. In other words, when both the portable terminal appliance 11 and the cordless handset 21 are set to the charging base 31, data as to an electronic mail and an address of an electronic mail stored in the portable terminal appliance data storage unit 12 is automatically transferred via the data transmitting and receiving unit 34 employed in the charging base 31 to the cordless handset 21, and then is stored in the cordless handset data storage unit 22.

When a user issues an instruction from the cordless handset data control unit 23, such an electronic mail whose content is wanted to be confirmed, and an electronic mail address which is wanted to be checked are retrieved (electronic mail address of MR. D is retrieved in FIG. 4). The electronic mail whose content is wanted to be retrieved so as to be confirmed, and the electronic mail address which is wanted to be checked can be confirmed by utilizing the cordless handset display unit 25 and the mother display unit 45. Also, an electronic mail can be formed and/or can be edited by using the cordless handset 21 and the base unit 41.

Further, the electronic mail address which has been registered in the cordless handset 21 may be transferred to the portable terminal appliance 11. Since an instruction is issued from the cordless handset data control unit 23 and the mother data control unit 43, an electronic mail and an electronic mail address may be alternatively transferred to the base unit 41 in a wireless manner, so that similar to the cordless handset 21, the user of the base unit 41 may alternatively confirm the content of the electronic mail, may alternatively check the electronic mail address, may alternatively form an electronic mail, and also, may alternatively provide such an electronic mail address registered in the base unit 41.

As previously explained, in accordance with this embodiment 4, since the electronic mail and the electronic mail address which have been registered in the portable terminal appliance 11 are automatically stored in the cordless handset data storage unit 22, the electronic mail and the electronic mail address which have been registered in the portable terminal appliance 11 can be confirmed by the cordless handset 21 and the base unit 41. Conversely, the electronic mails which are formed in the cordless handset 21 and the base unit 41 can be provided to the portable terminal appliance 11, and also the electronic mail addresses which have been registered in the cordless handset 21 and the base unit 41 can be provided to the portable terminal appliance 11.

### Embodiment 5

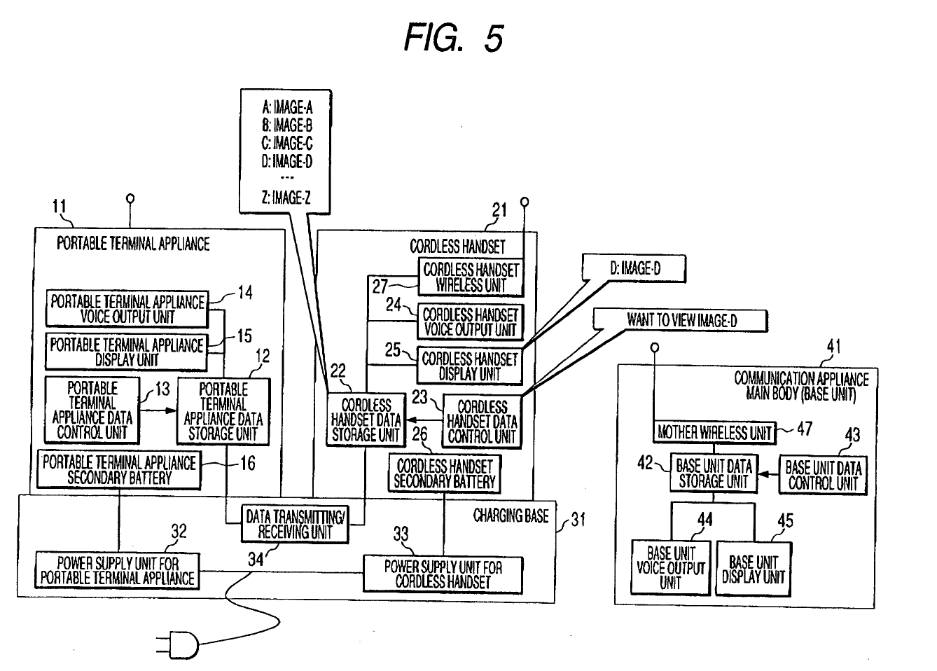

FIG. 5 is a schematic block diagram for representing a communication system according to an embodiment 5 of the present invention. In FIG. 5, a portable terminal appliance 11, a portable terminal appliance data storage unit 12, a portable terminal appliance data control unit 13, a portable terminal appliance voice output unit 14, a portable terminal appliance display unit 15, a portable terminal appliance secondary battery 16, a cordless handset 21, a cordless handset data storage unit 22, a cordless handset data control unit 23, a cordless handset voice output unit 24, a cordless handset display unit 25, a cordless handset secondary battery 26, a cordless handset wireless unit 27, a charging base 31, a power supply unit 32 for portable terminal appliance; a power supply unit 33 for cordless handset; a data transmitting and receiving unit 34; a communication appliance main body (base unit) 41, a base unit data storage unit 42, a base unit data control unit 43, a base unit voice output unit 44, abase unit display unit 45, and also, a mother wireless unit 47 are similar to those of FIG. 1, and therefore, explanations thereof are omitted.

When both the portable terminal appliance 11 and the cordless handset 21 are set to the charging base 31, data of the portable terminal appliance data storage unit 12 is automatically is stored in the cordless handset data storage unit 22. As the data to be stored, an image such as a still image and a moving picture has been automatically stored. When a user issues an instruction from the cordless handset data control unit 23, a necessary image such as still image and a moving picture is retrieved (image “D” is retrieved in FIG. 5). Since the image such as the still image and the moving picture which is retrieved and is required is acquired, the user can view this acquired image such as the still image and the moving picture by utilizing the cordless handset display unit 26. Also, this image such as the still image and the moving picture may be alternatively set as a call-waiting screen of the cordless handset 21, and maybe alternatively edited. Furthermore, such an image as a still image and a moving picture, which has been formed, or acquired by the cordless handset 21 may be provided to the portable terminal appliance 11.

When a user issues an instruction from the cordless handset data control unit 23, or the base unit data control unit 43, the image such as the still image and the moving picture may be transferred to the base unit 41 in a wireless manner, and then, the image may be displayed on the base unit display unit 45 on the screen in a similar manner to that of the cordless handset 21, may be set as a call-waiting screen of the base unit 41, and may be edited in the base unit 41. Alternatively, such an image which has been formed, or acquired in the base unit 41 may be provided to the portable terminal appliance 11.

As previously explained, in accordance with this embodiment 5, since image such as the still image and the moving picture which has been registered in the portable terminal appliance 11 is automatically stored in the cordless handset data storage unit 22, the image such as the still image and the moving picture which has been registered in the portable terminal appliance 1 can be viewed in the cordless handset display unit 26 and the base unit display unit 45, can be set to the call-waiting screens of the cordless handset 21 and the base unit 41, and can be edited. Furthermore, the image such as the still image and the moving picture, which has been formed in the cordless handset 21 and the base unit 41, can be provided to the portable terminal appliance 11.

### Embodiment 6

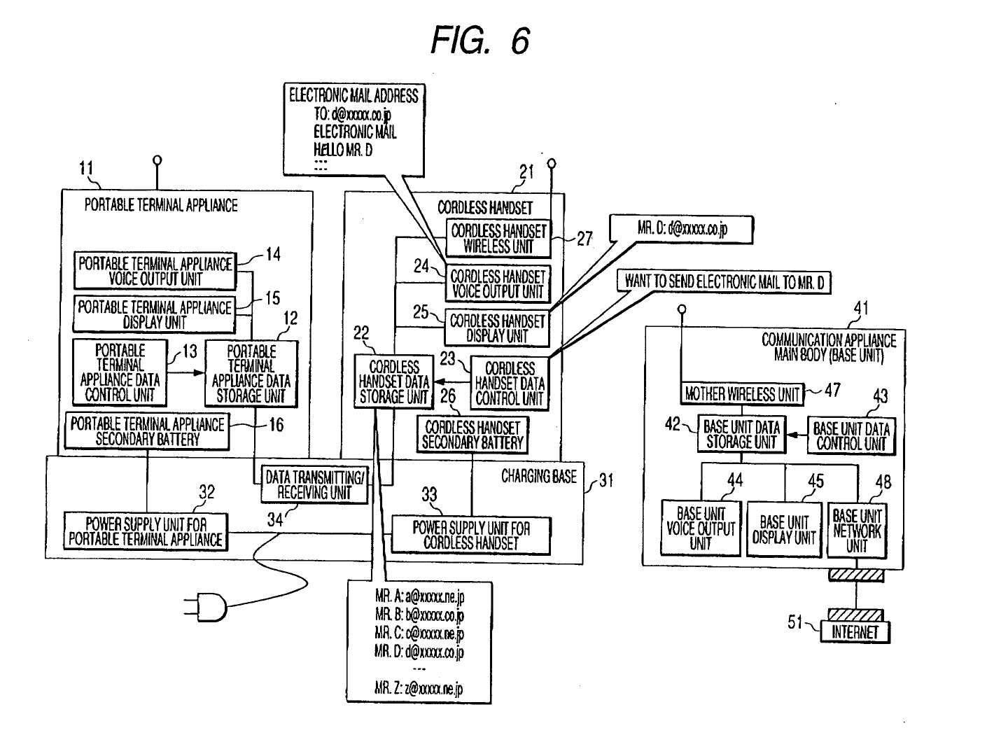

FIG. 6 is a schematic block diagram for representing a communication system according to an embodiment 6 of the present invention. In FIG. 6, a portable terminal appliance 11, a portable terminal appliance data storage unit 12, a portable terminal appliance data control unit 13, a portable terminal appliance voice output unit 14, a portable terminal appliance display unit 15, a portable terminal appliance secondary battery 16, a cordless handset 21, a cordless handset data storage unit 22, a cordless handset data control unit 23, a cordless handset voice output unit 24, a cordless handset display unit 25, a cordless handset secondary battery 26, a cordless handset wireless unit 27, a charging base 31, a power supply unit 32 for portable terminal appliance; a power supply unit 33 for cordless handset; a data transmitting and receiving unit 34; a communication appliance main body (base unit) 41, a base unit data storage unit 42, a base unit data control unit 43, a base unit voice output unit 44, a base unit display unit 45, and also, a mother wireless unit 47 are similar to those of FIG. 1, and therefore, explanations thereof are omitted.

A base unit network unit 48 is provided in the base unit 41, while this base unit network unit 48 is connectable to an external network such as the Internet. In FIG. 6, the base unit 41 is connected to the Internet 51 by way of this base unit network unit 48. Also, the portable terminal appliance 11 acquires information via the Internet 51, and is equipped with a view function.

As to the communication system which is arranged as explained above, a method for transmitting and receiving an electronic mail will be subsequently explained. It is so assumed that a plurality of electronic mail addresses have been stored as data to be stored in the cordless handset data storage unit 24. When a user issues an instruction from the cordless handset data control unit 23, such an electronic mail address which is required are retrieved (electronic mail is sent to MR. D in FIG. 6). As a result of retrieving operation, when the electronic mail address is acquired which is required, this acquired electronic mail address is transmitted via the cordless handset wireless unit 27 and the base unit wireless unit 47 to the base unit 41. Then; the base unit 41 stores this transmitted electronic mail address in the base unit data storage unit 42, and further, is connected via the base unit network unit 48 to the Internet 51, so that the base unit 41 can transmit an electronic mail to a counter party having this electronic mail address.

Also, a reception of an electronic mail by the base unit 41 can be realized by being connected via the base unit network unit 48 to the Internet 51.

After the received electronic mail is once stored in the base unit data storage unit 42, this electronic mail is transferred to the cordless handset 21. Furthermore, since the electronic mail address can be transferred from the cordless handset 21 to the base unit 41, the base unit 41 can be directly connected to the Internet 51, so that the electronic mail can be transmitted and received.

Next, a description will now be made of such an operation that information is provided to the portable terminal appliance 11 by utilizing the Internet 51. First, a user applies an instruction of URL (Uniform Resource Locator) which corresponds to a supply destination of desirable information to the portable terminal appliance 11, the cordless handset data control unit 23, or the base unit data control unit 43. Alternatively, the URL corresponding to the supply destination of the desirable information may be previously registered.

After the portable terminal appliance data storage unit 12 has been connected to the cordless handset data storage unit 22, either the URL designated by the user or the previously registered URL is transmitted via the cordless handset wireless unit 27 and the base unit wireless unit 47 to the base unit 41 so as to be stored in the base unit data storage unit 92 employed I the base unit 41. Also, the base unit 41 is connected to the Internet 51 by the base unit network 48 so as to be connected to a site of this URL. Then, the base unit 41 receives the provision of the required data via the Internet 51, and stores this data in the portable terminal appliance data storage unit 12.

As a sort of information which is provided from the Internet 51, there are news, music such as telephone-calling melody, images such as still images and moving pictures, time information used to adjust a time instance of the portable terminal appliance 11, and the like.

As previously described, in accordance with this embodiment 6, while the communication appliance main body 41 is equipped with the base unit network unit 48 which can be connected to the network such as the Internet 51, since either the cordless handset data storage unit 22 or the base unit data storage unit 42 owns the function capable of automatically storing the electronic mail address as the data, the instruction is issued from either the cordless handset data control unit 43 or the base unit data control unit 43, so that the electronic mail can be transmitted and received by utilizing the electronic mail address stored from either the cordless handset 21 or the base unit 41. While the portable terminal appliance 11 is not directly connected to the Internet 51, the necessary information is acquired by utilizing the charging operation as to the portable terminal appliance 11, and then, can be confirmed by the portable terminal 11. Furthermore, since the portable terminal appliance 11 and the cordless handset 21 are connected to each other by the data transmitting/receiving unit 34, or the like, a large amount of information can be quickly received, as compared with the method for directly connecting the portable terminal appliance 11, or the cordless handset 21 to the Internet 51.

### Embodiment 7

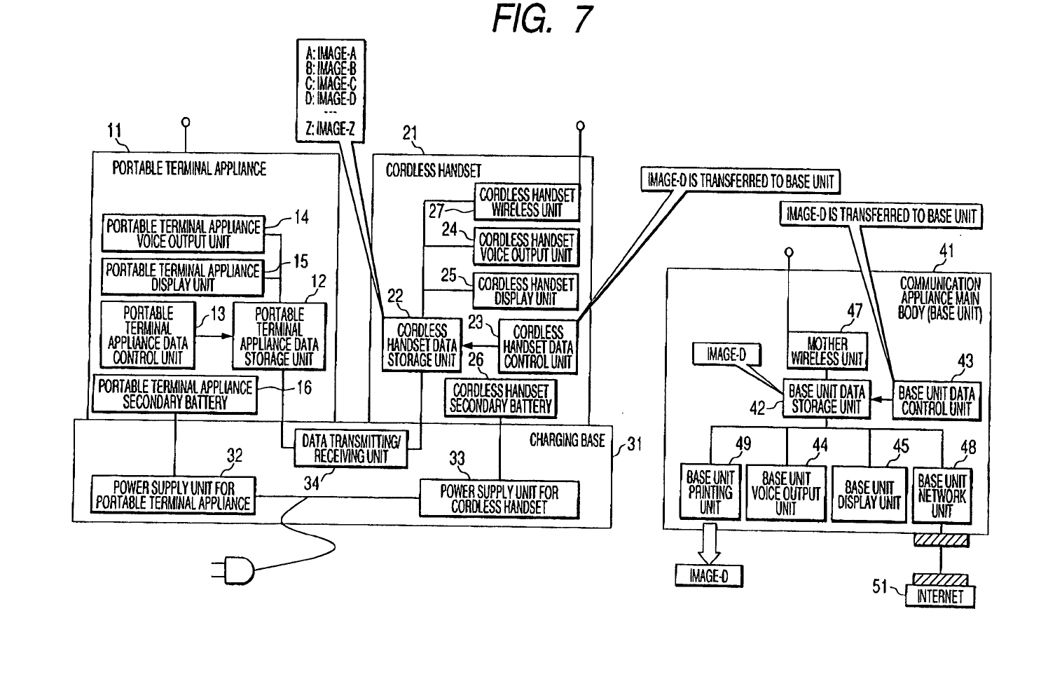

FIG. 7 is a schematic block diagram for representing a communication system according to an embodiment 7 of the present invention. In FIG. 7, a portable terminal appliance 11, a portable terminal appliance data storage unit 12, a portable terminal appliance data control unit 13, a portable terminal appliance voice output unit 14, a portable terminal appliance display unit 15, a portable terminal appliance secondary battery 16, a cordless handset 21, a cordless handset data storage unit 22, a cordless handset data control unit 23, a cordless handset voice output unit 24, a cordless handset display unit 25, a cordless handset secondary battery 26, a cordless handset wireless unit 27, a charging base 31, a power supply unit 32 for portable terminal appliance; a power supply unit 33 for cordless handset; a data transmitting and receiving unit 34; a communication appliance main body (base unit) 41, a base unit data storage unit 42, a base unit data control unit 43, a base unit voice output unit 44, a base unit display unit 45, a mother wireless unit 47, a base unit network unit 48, and also, the Internet 51 are similar to those of FIG. 6, and therefore, explanations thereof are omitted. Reference numeral 49 shows a base unit printing unit capable of printing data which has been stored in the base unit data storage unit 42.

A printing operation will now be described. First, in the case that such a data is printed which has been transferred from the data transmitting and receiving unit 34 via the portable terminal appliance data storage unit 12 to the cordless handset data storage unit 22 and has been stored in this cordless handset data storage unit 22, a user issues an instruction from the cordless handset data control unit 23 and the base unit data control unit 42 for providing necessary data within the data of the cordless handset data storage unit 22. The instructed data is stored via the cordless handset wireless unit 27 and the base unit wireless unit 47 to the base unit data storage unit 42. Then, the user applies an instruction to the base unit data control unit 43, so that the base unit 41 prints the instructed data by utilizing the base unit printing 49. Apparently, the base unit 41 can print such a data which has been originally acquired, or formed by the base unit data storage unit 42. As data to be printed, there are a telephone number, an electronic mail, an electronic mail address, and an image such as a still image and a moving picture.

### Embodiment 8

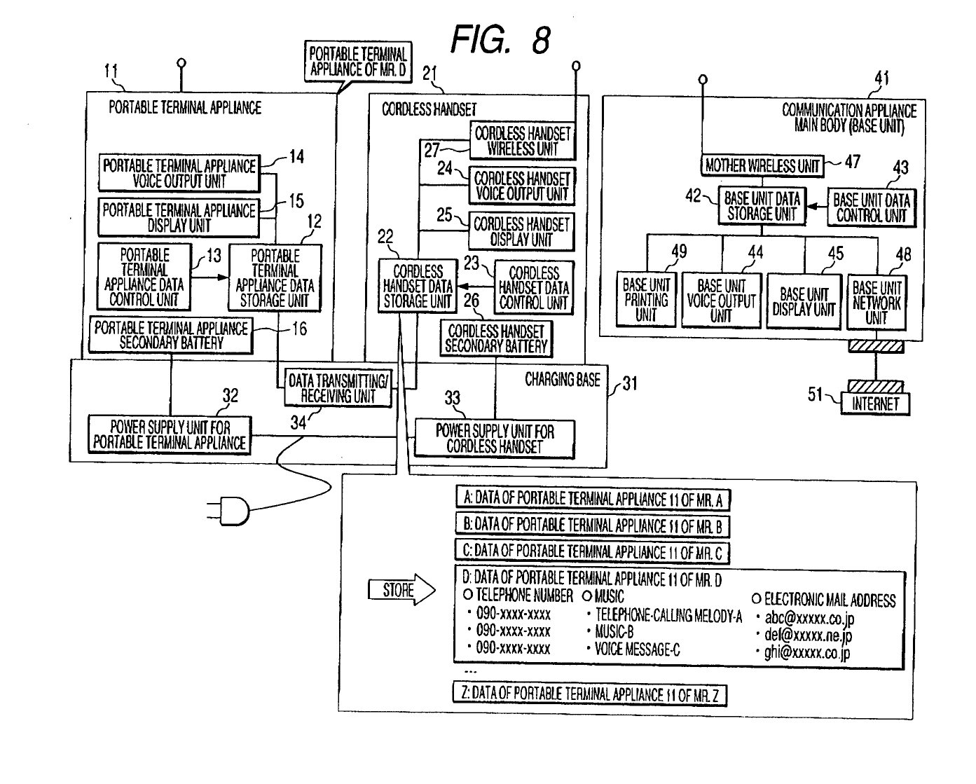

FIG. 8 is a schematic block diagram for representing a communication system according to an embodiment 8 of the present invention. In FIG. 8, a portable terminal appliance 11, a portable terminal appliance data storage unit 12, a portable terminal appliance data control unit 13, a portable terminal appliance voice output unit 14, a portable terminal appliance display unit 15, a portable terminal appliance secondary battery 16, a cordless handset 21, a cordless handset data storage unit 22, a cordless handset data control unit 23, a cordless handset voice output unit 24, a cordless handset display unit 25, a cordless handset secondary battery 26, a cordless handset wireless unit 27, a charging base 31, a power supply unit 32 for portable terminal appliance; a power supply unit 33 for cordless handset; a data transmitting/receiving unit 34; a communication appliance main body (base unit) 41, a base unit data storage unit 42, a base unit data control unit 43, a base unit voice output unit 44, a base unit display unit 45, a mother wireless unit 47, a base unit network unit 48, an Internet 51, and also, a base unit printing unit 49 are similar to those of FIG. 1, and therefore, explanations thereof are omitted. In this embodiment 8, the cordless handset data storage unit 22 is equipped with a function by which individual information as to portable terminal appliances connected to the cordless handset 21 is recognized, and data is individually stored every portable terminal appliance.

As to the communication system arranged in the above-described arrangement, operations thereof will now be explained. First of all, a portable terminal appliance 11 which is connected to the cordless handset 21 is individually registered in the cordless handset data control unit 23 as an initial setting condition. For instance, the portable terminal appliance 11 to be connected is registered every user. Since this portable terminal appliance 11 is registered, a place used to store data every registered portable terminal appliance 11 is secured in the cordless handset data storage unit 22.

Next, when a charging operation and a data transmitting/receiving operation of the portable terminal appliance 11 are carried out, the portable terminal appliance data storage unit 12 is connected to the cordless handset data storage unit 22 by employing the data transmitting/receiving unit 34, and the like. When the portable terminal appliance 11 is connected via the data transmitting/receiving unit 34 and the like to the cordless handset data storage unit 22, the cordless handset data control unit 23 automatically recognizes that this connected portable terminal appliance 11 corresponds to which registered portable terminal appliance 11. When the recognizing operation is automatically carried out, data is automatically stored in the corresponding data storage place every the registered portable terminal appliance 11. Since the above-described arrangement is provided, the storage place of the data which corresponds to the previously registered portable terminal appliance 11 can be secured in the cordless handset data storage unit 22. As a result, the data can be stored in such data formats which can be utilized with respect to each of the users, so that it is possible to avoid that the above-described data is mixed with the data of other users.

### Embodiment 9

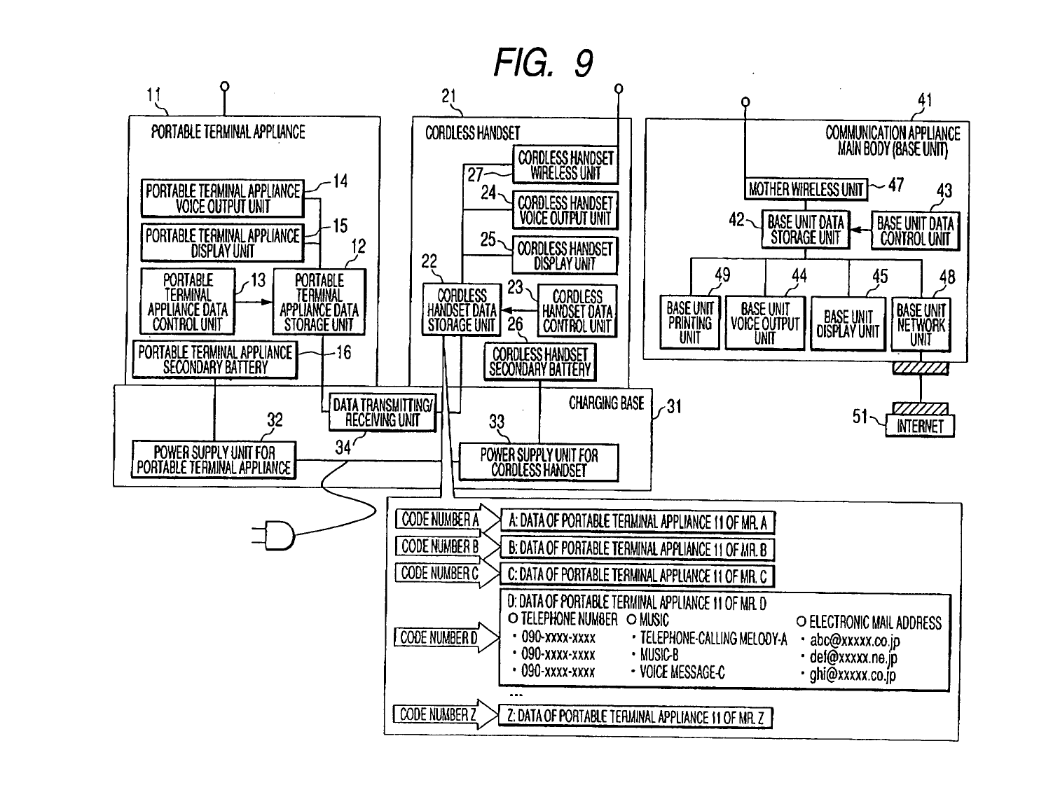

FIG. 9 is a schematic block diagram for representing a communication system according to an embodiment 9 of the present invention. In FIG. 9, a portable terminal appliance 11, a portable terminal appliance data storage unit 12, a portable terminal appliance data control unit 13, a portable terminal appliance voice output unit 14, a portable terminal appliance display unit 15, a portable terminal appliance secondary battery 16, a cordless handset 21, a cordless handset data storage unit 22, a cordless handset data control unit 23, a cordless handset voice output unit 24, a cordless handset display unit 25, a cordless handset secondary battery 26, a cordless handset wireless unit 27, a charging base 31, a power supply unit 32 for portable terminal appliance; a power supply unit 33 for cordless handset; a data transmitting/receiving unit 34; a communication appliance main body (base unit) 41, a base unit data storage unit 42, a base unit data control unit 43, a base unit voice output unit 44, a base unit display unit 45, a mother wireless unit 47, a base unit network unit 48, an Internet 51, and also, a base unit printing unit 49 are similar to those of FIG. 8, and therefore, explanations thereof are omitted.

With respect to the communication system which is arranged in the above-described manner, operations of this communication system will now be described. In the cordless handset data storage unit 22 described in the embodiment 9, a password number is set. When data storage in the cordless handset data storage unit 22 is used, a password number is entered in the cordless handset data control unit 23, and then, if identification is accepted in the cordless handset data storage unit 22, then the data stored in the cordless handset data storage unit 22 can be utilized within such a range that the identification is accepted with employment of this arrangement, it is possible to avoid that such a data which has been stored from the portable terminal appliance 11 to the cordless handset data storage unit 25 is easily viewed and/or utilized by other users.

### Embodiment 10

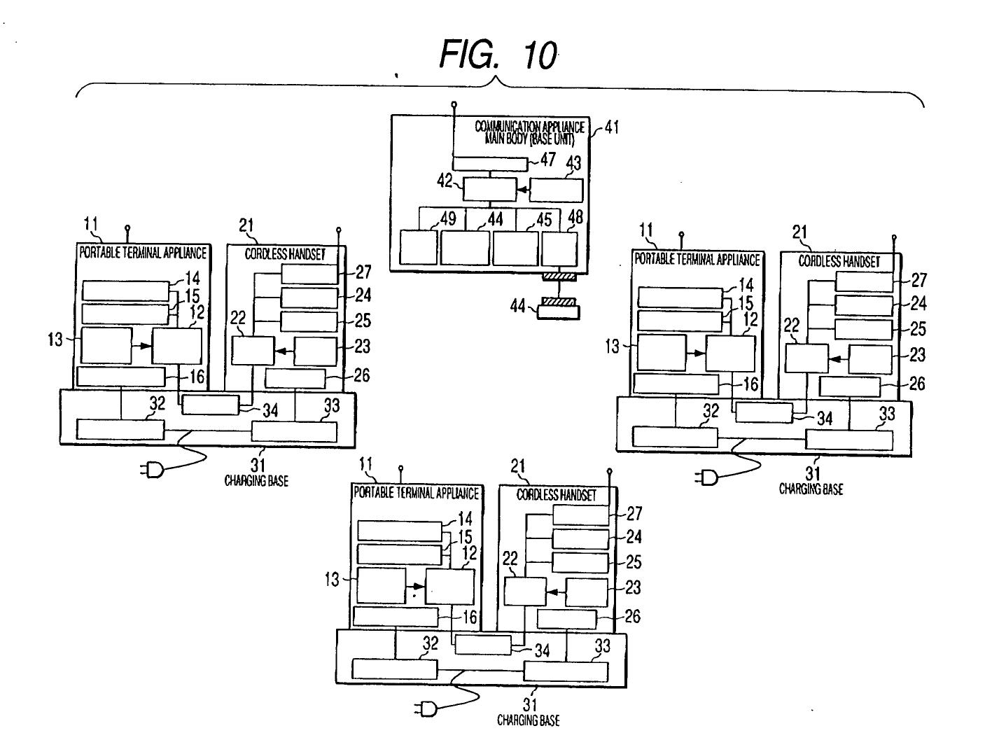

FIG. 10 is a schematic block diagram for representing a communication system according to an embodiment 10 of the present invention. In FIG. 10, a portable terminal appliance 11, a portable terminal appliance data storage unit 12, a portable terminal appliance data control unit 13, a portable terminal appliance voice output unit 14, a portable terminal appliance display unit 15, a portable terminal appliance secondary battery 16, a cordless handset 21, a cordless handset data storage unit 22, a cordless handset data control unit 23, a cordless handset voice output unit 24, a cordless handset display unit 25, a cordless handset secondary battery 26, a cordless handset wireless unit 27, a charging base 31, a power supply unit 32 for portable terminal appliance; a power supply unit 33 for cordless handset; a data transmitting/receiving unit 34; a communication appliance main body (base unit) 41, a base unit data storage unit 42, a base unit data control unit 43, a base unit voice output unit 44, a base unit display unit 45, a mother wireless unit 47, a base unit network unit 48, an Internet 51, and also, a base unit printing unit 49 are similar to those of FIG. 9, and therefore, explanations thereof are omitted. In this embodiment 10, as indicated in FIG. 10, this communication system is equipped with the base unit 41, plural sets of the portable terminal appliances 11, plural sets of the cordless handsets 21, and plural sets of the charging bases 31. In this communication system, data can be transmitted and received between the plural sets of the portable terminal appliances 11 and the plural sets of the cordless handsets at the same time.

Also, the plural sets of the portable terminal appliances 11 can be charged at the same time. It should also be noted that a set of each portable terminal appliance 11, each cordless handset 21, and each charging base 31 may play the same role as that explained in the above-explained embodiments 1 to 10.

### Embodiment 11

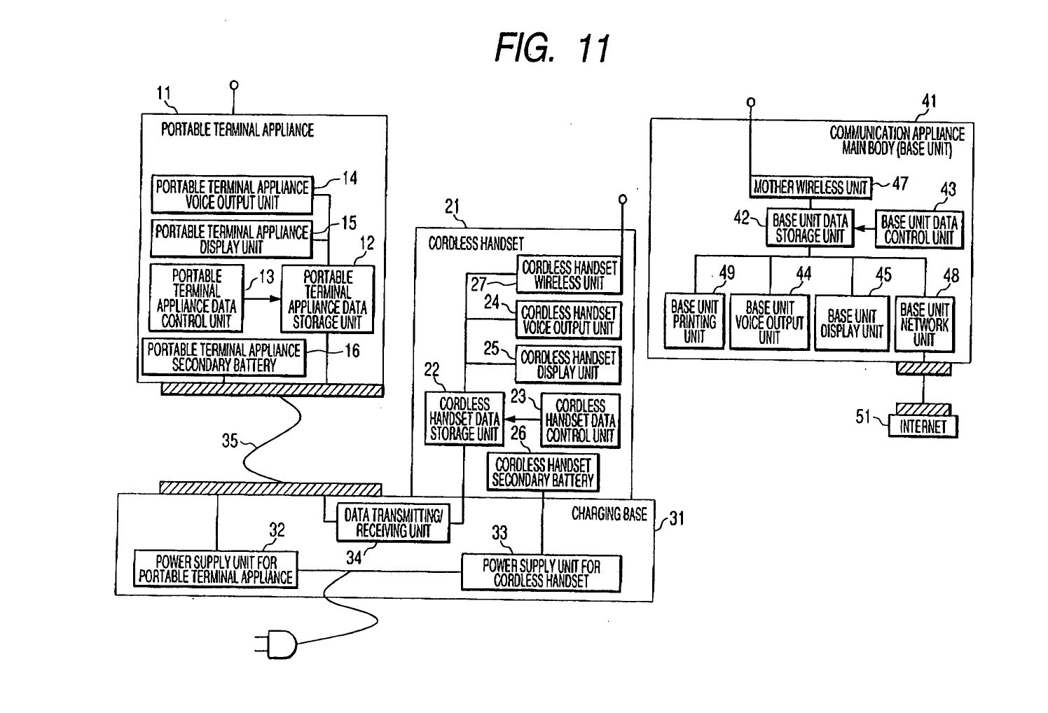

FIG. 11 is a schematic block diagram for representing a communication system according to an embodiment 11 of the present invention. In FIG. 11, a portable terminal appliance 11, a portable terminal appliance data storage unit 12, a portable terminal appliance data control unit 13, a portable terminal appliance voice output unit 14, a portable terminal appliance display unit 15, a portable terminal appliance secondary battery 16, a cordless handset 21, a cordless handset data storage unit 22, a cordless handset data control unit 23, a cordless handset voice output unit 24, a cordless handset display unit 25, a cordless handset secondary battery 26, a cordless handset wireless unit 27, a charging base 31, a power supply unit 32 for portable terminal appliance; a power supply unit 33 for cordless handset; a data transmitting/receiving unit 34; a communication appliance main body (base unit) 41, a base unit data storage unit 42, a base unit data control unit 43, a base unit voice output unit 44, a base unit display unit 45, a mother wireless unit 47, a base unit network unit 48, an Internet 51, and also, a base unit printing unit 49 are similar to those of FIG. 7, and therefore, explanations thereof are omitted. In this embodiment 11, communication system is equipped with a communication cable 35. This communication cable 35 is arranged between the portable terminal appliance 11 and the charging base 31, and owns such a function that a charging current is supplied so as to charge the portable terminal appliance secondary battery 16 provided in the portable terminal appliance 11. Also, the communication cable 35 penetrates a signal therethrough while data is transmitted and received between the portable terminal appliance 11 and the cordless handset 21.

As to the communication system arranged in the above-described manner, operations thereof will now be explained. First, a user connects the portable terminal appliance 11 to the communication cable 35, and installs the cordless handset 21 on the charging base 31. As a result, the portable terminal appliance secondary battery 16 is connected to the portable terminal appliance power supply unit 32, and furthermore, the cordless handset secondary battery 26 is connected to the cordless handset power supply unit 33. In addition, the portable terminal appliance data storage unit 12 is connected via the data transmitting/receiving unit 34 to the cordless handset data storage unit 22. Since these structural units of the communication system are connected to each other, similar to the embodiment 1, or the embodiment 2, the charging operation of the portable terminal appliance 11 is carried out, and also, the data transmitting and receiving operations are carried out among three structural units, namely, the portable terminal appliance 11, the cordless handset 21, and the base unit 41.

What is claimed is:

1. A communication apparatus comprising:
a base unit equipped with a mother wireless unit for transmitting and receiving data between the own base unit and a cordless handset in a wireless manner;
a cordless handset including: a cordless handset wireless unit for transmitting and receiving data between the own cordless handset and the base unit in a wireless manner; a cordless handset secondary battery which constitutes a power supply; a cordless handset data storage unit capable of storing data; and a cordless handset voice output unit for outputting voice; and
a charging base including: a cordless handset power supply unit for charging said cordless handset secondary buttery; a portable terminal appliance power supply unit for charging a portable terminal appliance; and a data transmitting and receiving unit capable of transmitting and receiving data between the portable terminal appliance and said cordless handset data storage unit;
wherein since the data is transmitted and received between the portable terminal appliance and the cordless handset by the data transmitting/receiving unit of said charging base, the data which is acquired on the side of the portable terminal appliance is transferred to the data storage unit employed in the cordless handset.

2. A communication apparatus comprising:
a cordless handset including:
a cordless handset data storage unit capable of storing thereinto data;
a cordless handset data control unit for controlling operation of the cordless handset by utilizing said data stored in said cordless handset data storage unit;
a cordless handset display unit for displaying thereon various sorts of information;
a cordless handset voice output unit for outputting voice;
a cordless handset wireless unit for transmitting and receiving data between the own cordless handset and the base unit in a wireless manner; and
a cordless handset secondary battery which constitutes a power supply of said cordless handset;
a base unit including:
a base unit data storage unit capable of storing thereinto data;
a base unit data control unit for controlling operation of the base unit by utilizing said data stored in said base unit data storage unit;
a base unit display unit for displaying thereon various sorts of information;
a base unit voice output unit for outputting voice; and
a base unit wireless unit for transmitting and receiving data between the own base unit and the cordless handset in a wireless manner; and
a charging base including:
a cordless handset power supply unit for charging said cordless handset secondary battery;
a portable terminal appliance power supply unit for charging said portable terminal appliance; and
a data transmitting and receiving unit capable of transmitting and receiving data between the portable terminal appliance and the cordless handset data storage unit.

3. A communication system comprising:
a base unit equipped with a mother wireless unit for transmitting and receiving data between the own base unit and a cordless handset in a wireless manner;
a cordless handset including: a cordless handset wireless unit for transmitting and receiving data between the own cordless handset and the base unit in a wireless manner; a cordless handset secondary battery which constitutes a power supply; a cordless handset data storage unit capable of storing data; and a cordless handset voice output unit for outputting voice;
a charging base including: a cordless handset power supply unit for charging said cordless handset secondary buttery; a portable terminal appliance power supply unit for charging a portable terminal appliance; and a data transmitting and receiving unit capable of transmitting and receiving data between the portable terminal appliance and said cordless handset data storage unit; and
a portable terminal appliance including: a portable terminal appliance data storage unit capable of storing data; a portable terminal appliance display unit for displaying thereon various sorts of information; a portable terminal appliance voice output unit for outputting voice; and a portable terminal appliance secondary battery which constitutes a power supply,
wherein under such a condition that both the portable terminal appliance and the cordless handset are set to said charging base, both said portable terminal appliance power supply unit and said cordless handset power supply unit charge both said portable terminal apparatus secondary battery and the cordless handset secondary battery, and also, the data transmitting and receiving unit of said charging base can transmit and receive the data between the portable terminal appliance and the cordless handset.

4. A communication system comprising:
a cordless handset including:
a cordless handset data storage unit capable of storing thereinto data;
a cordless handset data control unit for controlling operation of the cordless handset by utilizing said data stored in said cordless handset data storage unit;
a cordless handset display unit for displaying thereon various sorts of information;
a cordless handset voice output unit for outputting voice;
a cordless handset wireless unit for transmitting and receiving data between the own cordless handset and the base unit in a wireless manner; and
a cordless handset secondary battery which constitutes a power supply of said cordless handset;
a base unit including:
a base unit data storage unit capable of storing thereinto data;
a base unit data control unit for controlling operation of the base unit by utilizing said data stored in said base unit data storage unit;
a base unit display unit for displaying thereon various sorts of information;
a base unit voice output unit for outputting voice; and a base unit wireless unit for transmitting and receiving data between the own base unit and the cordless handset in a wireless manner;
a portable terminal appliance including:
a portable terminal appliance data storage unit capable of storing thereinto data;
a portable terminal appliance data control unit for controlling operation of the portable terminal appliance by utilizing said data stored in said portable terminal appliance data storage unit;
a portable terminal appliance display unit for displaying thereon various sorts of information;
a portable terminal appliance voice output unit for outputting voice; and
a portable terminal appliance secondary battery which constitutes a power supply of said portable terminal appliance; and
a charging base including:
a portable terminal appliance power supply unit for charging said portable terminal appliance;
a cordless handset power supply unit for charging said cordless handset secondary battery; and
a data transmitting/receiving unit capable of transmitting/receiving data between the portable terminal appliance and the cordless handset data storage unit.

5. A communication system as claimed in claim 3 or 4, wherein the data which is intended to be transmitted and received between said portable terminal appliance and said cordless handset, or between said cordless handset and said base unit, or between said portable terminal appliance and said base unit corresponds to a telephone number.

6. A communication system as claimed in claim 3 or 4, wherein the data which is intended to be transmitted and received between said portable terminal appliance and said cordless handset, or between said cordless handset and said base unit, or between said portable terminal appliance and said base unit corresponds to music such as telephone-calling melody.

7. A communication system as claimed in claim 3 or 4, wherein the data which is intended to be transmitted and received between said portable terminal appliance and said cordless handset, or between said cordless handset and said base unit, or between said portable terminal appliance and said base unit corresponds to an image such as a still image and a moving picture.

8. A communication system as claimed in claim 3 or 4, wherein the data which is intended to be transmitted and received between said portable terminal appliance and said cordless handset, or between said cordless handset and said base unit, or between said portable terminal appliance and said base unit corresponds to an electronic mail, or an address of an electronic mail.

9. A communication system as claimed in claim 3 or 4, wherein said base unit includes a base unit network which is connectable to an external information network such as the Internet.

10. A communication system as claimed in claim 3 or 4, wherein said base unit includes a base unit printing unit for printing data which is derived from said base unit data storage unit.

11. A communication system as claimed in claim 3 or 4, wherein said cordless handset data storage unit is comprised of a function for recognizing individual information of a portable terminal appliance connected to said cordless handset, and for storing said data in an individual manner.

12. A communication system as claimed in claim 3 or 4, wherein said cordless handset data storage unit is comprised of a protection function of data by way of a code number.

13. A communication system as claimed in claim 3 or 4, further comprising:
a base unit capable of transmitting and receiving data with respect to plural sets of said cordless handsets and plural sets of said portable terminal appliances in a wireless manner.

14. A communication system as claimed in claim 3 or 4, further comprising:
a communication cable equipped with such a function by which a charging current for charging a secondary battery employed in a portable terminal appliance is supplied from said charging base, and a signal for transmitting/receiving data between the portable terminal appliance and the cordless handset is penetrated through said communication cable.
